(19) United States
(12) Patent Application Publication
(10) Pub. No.: US 2018/0285957 A1
(43) Pub. Date: Oct. 4, 2018

(54) RECOMMENDATION SYSTEM ASSOCIATED WITH AN ONLINE MARKETPLACE

(71) Applicant: Ten-X, LLC, Irvine, CA (US)

(72) Inventors: Edwin Ng, Irvine, CA (US); Christopher Dumas, Irvine, CA (US); Charles McKinney, Irvine, CA (US); William Wolf Rendall, Irvine, CA (US)

(21) Appl. No.: 15/476,426

(22) Filed: Mar. 31, 2017

(51) Int. Cl. G06Q 30/06; G06Q 10/06; G06N 5/04; G06N 99/00

(52) U.S. Cl. CPC G06Q 30/0631; G06N 99/005; G06N 5/04; G06Q 10/067

(57) ABSTRACT

A recommendation system associated with an online marketplace can generate recommendations pertaining to users and assets of the online marketplace by computing user-asset propensity scores. The recommendation system can compute a corresponding user-asset propensity score for each unique user-asset combination. Based on the scores, recommendations indicating predicted user behavior can be generated. To generate the user-asset propensity scores, the recommendation system can generate machine-learned models based on training data. The model can comprise a plurality of classifiers each being associated with user-asset attributes.

### BACKGROUND

Online marketplaces provide a venue for users to transact for various kinds of assets, including collectibles, electronics, real property assets, and other goods or services. Recommendation engines also exist for online marketplaces. Typical approaches for conventional recommendation engines can consider a particular buyer's preferences and other information, and generating a recommendation for the particular buyer by identifying comparable assets that are likely to satisfy the particular buyer's preferences and other information. Such approaches have varying degrees of effectiveness.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example recommendation system, in accordance with examples described herein;

FIG. 2 is a flowchart diagram describing an example method of generating a recommendation based on user-asset propensity scores, in accordance with examples described herein;

FIG. 3 is a flowchart diagram describing an example method of generating a user-asset propensity score using classifiers, in accordance with examples described herein;

FIG. 4A is a diagram illustrating an example subset of correlation data for generating a decision tree classifier, in accordance with examples described herein;

FIG. 4B is a diagram illustrating an example decision tree classifier for generating a classifier outcome, in accordance with examples described herein; and

FIG. 5 is a block diagram that illustrates a computer system upon which examples described herein may be implemented.

### DETAILED DESCRIPTION

Examples described herein pertain generally to a recommendation system for non-fungible assets, such as real property assets, for sale on an online marketplace (e.g., online auction forum). A recommendation system and method are provided for generating recommendations regarding assets for sale on the online marketplace based on computed user-asset propensity scores. The recommendation system can compute a respective user-asset propensity score for each user-asset pair. In other words, in an online marketplace having 1,000 users and 100 non-fungible assets for sale, the recommendation system can compute 100,000 unique user-asset propensity scores, one for each unique combination of user and asset. In this manner, the recommendation system can generate a recommendation for a particular user (e.g., a recommendation regarding assets the particular user is most likely interested in) based on the user-asset propensity scores associated the particular user. Similarly, the recommendation system can generate a recommendation for a particular asset (e.g., a recommendation regarding users who are most likely interested in the particular asset) based on the user-asset propensity scores associated with the particular asset.

In various aspects, the recommendation system can compute the user-asset propensity scores using a machine-learned model generated by the recommendation system based on data collected by the online marketplace. The data can indicate past user activity or behavior with respect to assets for sale on the online marketplace. For example, the data can indicate whether a particular user submitted a bid on a particular property. The data can also indicate values for various characteristics or attributes regarding the user and the asset (user-asset attributes). Thus, the machine-learned model can reflect correlations between user-asset attributes and past user behavior (e.g., as reflected in the data collected by the online marketplace). Predictions regarding future user behavior or user preferences on the online marketplace can be obtained using the model. For instance, the recommendation engine can compute a user-asset propensity score that quantifies the affinity of the user towards the asset, relative to other users and other properties. In one implementation, a higher user-asset propensity score indicates that the corresponding user is more likely to be interested in or submit a bid on the asset.

Embodiments described herein realize substantial benefits over conventional recommendation systems that generate recommendations based on buyer preferences and identifications of comparable properties. For instance, conventional systems cannot quantify a likelihood a particular user will submit a bid (or take other actions) with respect to a particular property. Thus, it is impossible to generate comparisons to determine, for example, the five users determined to be most likely among the user base of the online market system to submit bids on a particular property. In contrast, embodiments here enable user-asset propensity scores to be computed for each unique user-asset pair. As a result, a user-asset pair can have a normalized numeric score that can be compared against another user-asset pair. This enables the recommendation system to generate highly dynamic and highly specific recommendations to administrators and users of the recommendation. For instance, the recommendation system can determine the top ten assets on which a particular user is likely to submit bids based on user-asset propensity scores. Similarly, the recommendation system can determine the top ten users who are likely to submit bids on a particular asset. Recommendations can be generated based on such determinations. For example, the recommendation system can generate a specific and dynamic recommendation regarding properties to advertise to a particular user of the online marketplace. Such recommendations can be generated for an administrator or agent of the online marketplace or of the recommendation system. Similarly, the recommendation system can generate a specific and dynamic recommendation regarding users to whom to advertise a particular asset. Such dynamic specificity cannot be achieved by conventional recommendation systems.

Such recommendations generated by the recommendation system can improve the efficiency of the online marketplace by, for example, allowing for improved targeted advertising. This achieves the technical effect of improving throughput of the online marketplace. For example, using recommendations generated by the recommendation system can, transaction rates and bidding activity on the online marketplace can be increased and assets can be transacted faster. Therefore, processing and storage resources network systems implementing the online marketplace can be conserved for additional assets for listing on the online marketplace.

In addition, conventional recommendation systems are prone to inaccuracies caused by errors in selecting comparable assets or identifying user preferences. By using one or more machine-learning algorithms to generate models based on a large set of training data to determine user-asset propensity scores, examples described herein provide a more robust approach in generating recommendations.

In various examples, the recommendation system can maintain user records associated with users of the online marketplace. The user records can include information regarding user activity on the online marketplace. For instance, a user record can include data that indicates a user has logged on to the online marketplace within the past 10 days. As another example, the user record can also include data that indicates that the user has submitted a bid for property for sale on the online marketplace within the past 30 days. The user records can also include personal data, such as the user's home address, income, etc. The recommendation system can also maintain asset records. Asset records can include data regarding asset attributes. For instance, an asset record can include data indicating the number of days the asset has been for sale on the online marketplace. In the context of a real property asset, the asset record can include data regarding the address, the square footage, the number of bedrooms, the number of bathrooms, and the lot size of the real property asset, and the like.

According to embodiments, the recommendation system can retrieve, from a database accessible to or within the recommendation system, data to generate the machine-learned model. Such data can be referred to as training data. A record in the training data can be associated with a particular user and a particular asset and can have a known outcome (e.g., whether the user submitted a bid on the property). The record can also include information from an associated user record (e.g., user record of the particular user) and information from an associated asset record (e.g., asset record of the particular asset). The training data record can include, for example, information regarding activity of the particular user with respect to the particular asset (e.g., views, searches, save as favorite, bids, offers, etc.). The training data record can also indicate activity of the particular user with respect to assets identified as comparable assets to the particular asset (e.g., whether the user submitted bids on assets identified as comparable assets).

As described herein, the training data can be analyzed to identify a set of user-asset attributes. The set of user-asset attributes can include any characteristic regarding the user and/or the asset for which data or information is maintained by the online marketplace and/or the recommendation system. Some user-asset attributes can be associated with a user. For example, one user-asset attribute can be a home address of the user. Another user-asset attribute can be the user's stated preference in assets (e.g., the number of preferred bathrooms). Other user-asset attributes associated with the user can include the number of times the user has logged into the online marketplace within a period of time (e.g., within the past ten days). Some user-asset attributes can be associated with an asset. For example, a user-asset attribute associated with the asset can be a characteristic describing the asset (e.g., number of bedrooms, number of bathrooms). Another user-asset attribute associated with the asset can be the number of days the asset has been listed for sale on the online marketplace. Certain user-asset attributes can be associated with both the user and the asset. For instance, one such user-asset attribute can correspond to whether the asset is located within ten miles of the user's home address. Another such user-asset attribute can correspond to whether the user submitted one or more bids on assets that are deemed comparable to the asset in question.

According to embodiments, the set of user-asset attributes can be determined by an administrator or programmer of the recommendation system. As an alternative or in addition, the user-asset attributes can be determined programmatically by the recommendation system. The set of user-asset attributes can be identified by determining correlations between characteristics of users and/or assets and the known outcomes. As one example, the recommendation system can determine that users are more likely to submit bids on assets they have saved as favorites in their user profiles associated with online marketplace. Thus, whether a particular user has saved a particular asset as a favorite can be identified as a user-asset attribute. As another example, the recommendation system can determine that users are more likely to submit bids on assets located within ten miles of the users' locations (or users' home address). Accordingly, whether a particular user is located within ten miles of a particular asset can similarly be identified as a user-asset attribute. The set of user-asset attributes can be periodically updated based on updated training data. In some examples, the set of user-asset attributes can be programmatically updated in response to detecting that training data has been updated.

In certain implementations, the machine-learned model can comprise a plurality of classifiers. A classifier can be a programmatic construct or algorithm generated by the recommendation system to compute a classification with respect to a particular outcome relating to a user-asset combination. For instance, the classifier for a user-asset combination can output a binary value indicating whether it is likely that the user will submit a bid on the asset. The classifier output can also indicate, for example, whether the user is likely to be interested in the asset, etc. The plurality of classifiers can be generated by the recommendation system using the training data based on the identified set of user-asset attributes. For instance, the recommendation system can parse the training data to retrieve values of the user-asset attributes and the classifiers can be generated using the training data values of the user-asset attributes.

In certain implementations, the plurality of classifiers can be tree-based classifiers (e.g., decision trees). In some examples, a random approach is used with respect to the plurality of classifiers (e.g., a random forest of decision trees). In particular, each of the plurality of classifiers can be associated with a corresponding, randomly-selected subset of the set of user-assets attributes. To generate a first classifier, the recommendation system can select a first random subset of user-asset attributes from the set of user-asset attributes. For example, out of a set of fifty user-asset attributes, the recommendation system can randomly select five user-asset attributes for the first classifier. Based on the selection of the first subset of user-asset attributes, the recommendation system can generate the first classifier based on training data values for the first subset of user-asset attributes. To generate a second classifier, the recommendation system can select a second random subset of user-asset attributes from the set of user-asset attributes. For example, out of the set of fifty user-asset attributes, the recommendation system can randomly select seven user-asset attributes for the second classifier. Based on the selection of the second subset of user-asset attributes, the recommendation system can generate the second classifier based on training data values for the second subset of user-asset attributes.

In the examples described herein, to compute a classifier output for a user-asset pair, data associated with the user and/or the asset of the user-asset pair is used. For example, the user record of the user and the asset record of the asset can be retrieved and parsed to retrieve relevant inputs to the classifier. Inputs to the classifier can include values of the subset of user-asset attributes associated with the classifier. For example, a classifier can be associated with a user-asset attribute corresponding to whether the user has previously viewed the asset. The recommendation engine can parse the user and/or asset records of the user-asset pair and retrieve a value (e.g., a binary value of 1 or 0) indicating whether the user has viewed the asset on the online marketplace. The value can be one of the inputs to the classifier. The output of the classifier can be a binary value (e.g., 1 or 0) indicating whether, based on the user data relevant to the subset of user-asset attributes associated with the classifier, the user is likely to submit a bid on the asset. A classifier output of 1 can indicate that the user is determined to be likely to submit a bid on the asset and a classifier output of 0 can indicate that the user is determined to be unlikely to submit a bid on the asset.

In some examples, the recommendation system can determine the user-asset propensity score for a user-asset combination based on outputs of the plurality of classifiers. For instance, each of the plurality of classifiers for a user-asset combination can compute a 1 or 0 and the recommendation system can compute an average of the classifier outputs as the user-asset propensity score for the user-asset combination. For example, if 200 classifiers output 1 for the user-asset combination and 300 classifiers output 0, the recommendation system can determine the user-asset propensity score for the user-asset combination as 0.4. According to examples, a user-asset propensity score can be a measure of likelihood that the user is interested in or will submit a bid on the asset. Accordingly, comparing a first user-asset combination (a first user and a first asset) having a propensity score of 0.4 and a second user-asset combination (a second user and a second asset) having a propensity score of 0.2, the recommendation system can determine that the first user is more likely to submit a bid for the first asset via the online marketplace as compared with the second user submitting a bid for the second asset.

According to embodiments, the recommendation system can maintain a database of user-asset propensity scores to generate recommendations. The term “recommendation” includes any form of communication, whether direct (e.g., addressed to the person receiving the communication) or indirect (e.g., shown to the user in other context, such as through advertisement). For example, a recommendation can include a message, a notification, a portion of a search result, and/or web content provided as a portion of a web page. The recommendation system can access the user-asset propensity score database to generate recommendations regarding a particular user of the online marketplace or a particular asset for sale on the online marketplace. For instance, for a particular user, the recommendation system can generate a recommendation of top five or top ten properties for sale on the online marketplace based on user-asset propensity scores relevant to the particular user. Similarly, for a particular property, the recommendation system can generate a recommendation of top five or top ten users of the online marketplace based on user-asset propensity scores relevant to the particular property. In this manner, specific, targeted, and effective advertising (e.g., via email messages) can be generated for each specific user as well as for each specific property of the online marketplace.

In certain implementations, the recommendation system can generate different machine-learned models for different recommendations or user behavior forecasts. For instance, a machine-learned model can be generated to predict user behavior in submitting bids on assets within a timeframe of a week (e.g., predicting whether a particular user will submit a bid on a particular asset within a week). A different machine-learned model can be generated to predict user behavior in submitting bids on assets within a timeframe of a month (e.g., predicting whether a particular user will submit a bid on a particular asset within a month). In addition, different machine-learned models can be generated to predict user behavior for different geographic regions or markets. For instance, one machine-learned model can be generated for the Los Angeles market and another machine-learned model can be generated for the New York City market.

The term “fungible” refers to an item or quantity which can be replaced by another item or quantity. Examples of fungible items include a manufactured good, such as provided by a product line, which are often produced in large quantities (e.g., household goods, phone, etc.) Such items are fungible because they have equivalent replacements—for example, if a user makes a purchase of a household good from an online retailer and the item is shipped defective, the user cans simply request a replacement. In some instances, a user may purchase a non-brand but otherwise identical version of a fungible item. By way of contrast, non-fungible assets (or items) is intended to mean items which have attributes which have uniqueness or scarcity as compared to other items which are similar or of a same class. Examples of non-fungible assets include real-property assets, fine art items and other collectibles. While numerous examples are described below in context of real-property assets, embodiments such as described below can be applied to other kinds of non-fungible assets.

With regard to non-fungible items, examples described herein recognize that that available inventory can limit recommendations which use conventional approaches such as similarity comparison amongst assets. For example, the size, diversity and rate of change of the inventory can hinder effective similarity comparisons, at least at the granularity needed for recommendations to consistently effective. Moreover, non-fungible items are relatively unique, and non-fungible assets which share attributes can be scarce, particularly in comparison to the size of the people who may want to receive recommendations. Moreover, attributes which make one non-fungible asset appealing to one person may not be the reason why another user finds the non-fungible asset appealing, yet both individuals may find the asset appealing.

In this regard, online marketplaces in which non-fungible items are provided for transaction have challenges which are unique to the online environment. While a recommendation engine can increase interest and participation to such online marketplaces and thus facilitate turn-over of items which are actively listed for transaction (thereby more efficiently utilizing computing resources of the network system managing the online marketplaces), simply increasing traffic in this manner is not enough to optimize or generate efficient access of asset listings by a population of potential buyers. Embodiments recognize that when a recommendation engine employs similarity algorithms to recommend non-fungible items, a relatively small number of assets can be over-recommended. Likewise, when a recommendation system employs techniques to match users by preference similarities in order to recommend items that matching users liked to other matching users, the resulting recommendations also focus on a relatively small number of attributes. Thus, examples recognize that in the context of non-fungible assets such as real-estate, conventional recommendation processes tend to drive interest to only a subset of the asset pool and ignore a larger portion of the asset pool (even though items in the larger asset pool would have more interest to select people). Under conventional recommendation processes, many (if not most) of the items in the asset pool would become stale, and records corresponding to those assets would occupy memory resources for longer stretches of time, while other portions of the database system would experience disproportionately heavy loads from over recommended assets, thereby reducing the overall efficiency of the database, among other shortcomings.

For purpose of described examples, the term “user” or “users” is intended to mean a purchasing entity. While the term “user” can refer to person, the term “user” can also refer to a legal entity, such as a corporation or partnership.

As used herein, a “property asset” or “real-property asset” can refer to different types of real estate property, such as a single family residence, a condominium, an apartment, a commercial property, a parcel of land, or a note (e.g., mortgage).

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples of the invention can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Descriptions

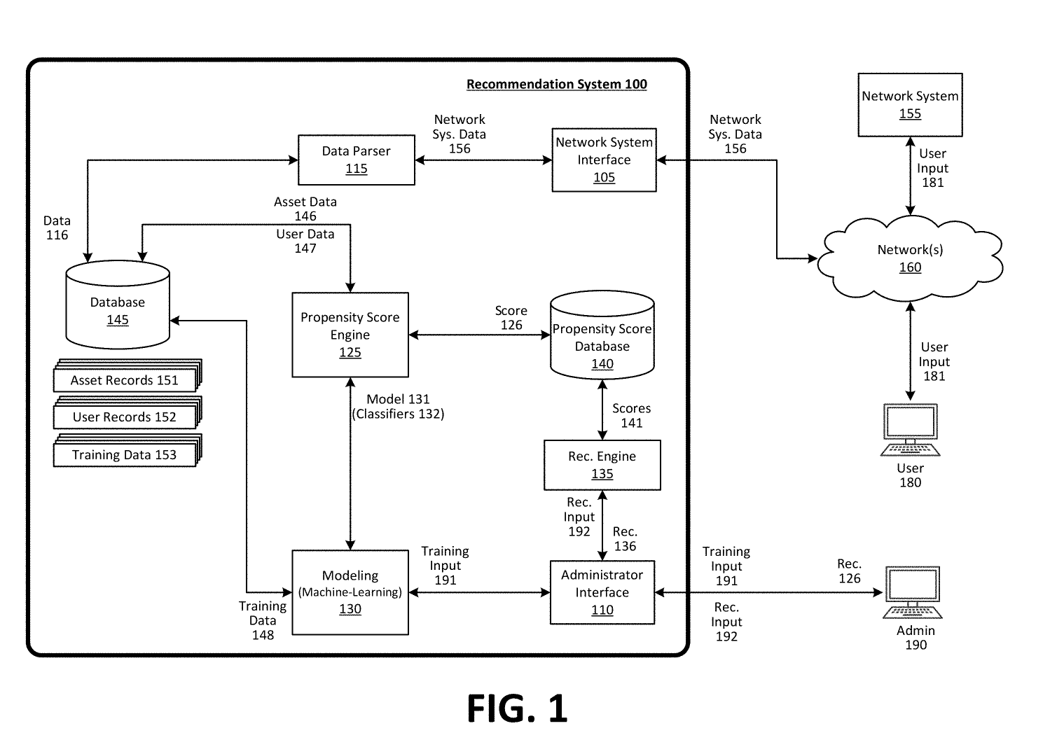

FIG. 1 is a block diagram illustrating an example recommendation system associated with an online marketplace, in accordance with examples described herein. The recommendation system 100 can generate recommendations for a particular user of the online marketplace, such as a compilation or list of assets on which the particular user is most likely interested in or most likely to submit a bid. Similarly, the recommendation system 100 can generate recommendations for a particular asset for sale on the online marketplace, such as a compilation or list of users who are most likely to bid on the particular asset.

In various examples, a network system 155 can implement the online marketplace. In particular, the network system 155 can, for example, receive user input 181 from user 180 of the online marketplace to view, search, and bid on assets for sale on the online marketplace. In doing so, the network system 155 can maintain user records, asset records, and transaction records, and other data pertaining to user activity that is relevant to the online marketplace. In one example, the online marketplace is an online auction forum for real estate assets.

According to embodiments, the recommendation system 100 can include a network system interface 105 to communicate, over network(s) 160, with a network system 155 that implements the online marketplace to receive network system data 156. The network system data 156 can be parsed by data parser 115 and transmitted to a database 145 for storage as data 116. The data 116 received by the database 145 can be stored as asset records 151, user records 152, and training data 153. In some examples, the training data 153 can be stored as part of the asset records 151 and user records 152. And in certain implementations, the database 145 can be a part of the network system 155 or another computing system(s).

According to embodiments, the recommendation system 100 can perform machine learning using training data 153 to generate machine-learned models (e.g., random forest model, neural network, etc.) that can render predictions regarding future user behavior. For instance, the models can output user-asset propensity scores that correspond to likelihoods users will submit bids assets. Examples contemplate that the recommendation system 100 can compute a respective user-asset propensity score for each unique combination of user and asset. The machine-learned models can comprise a plurality of classifiers (e.g., decision tree classifiers, artificial neurons, perceptrons, etc.).

According to some examples, the recommendation system 100 can include modeling (machine-learning) 130 to generate the machine-learned models 131. The modeling 130 receives training data 148 from the database 145. In some implementations, the modeling 130 can programmatically determine a set of user-asset attributes based on which the model 131 can be generated. In other examples, the modeling 130 receives, via an administrator interface 110, training input 191 from an administrator 190 that indicates the identification of the set of user-asset attributes.

According to embodiments, the administrator interface 110 can communicate with the administrator 190 via a local interconnection. In other examples, the administrator interface 110 can receive input from the administrator 190, such as training input 191, over a network such as network(s) 160. In addition to identifying user-asset attributes, the training input 191 can indicate one or more parameters associated with the generation of the model 131, such as a relevant timeframe. For instance, the model 131 can be generated to be predictive of user behavior within a two-week timeframe (e.g., indicating whether, for example, a user is likely to submit a bid on an asset within the two-week timeframe). In various implementations, the modeling 130 can generate different models for different relevant timeframes.

For example, the administrator 190 can input training input 191 to select a set of user-asset attributes to generate the model 131. The administrator 190 can select user-asset attributes associated with the user (e.g., whether the user has logged in to the online marketplace in the last 3 days), user-asset attributes associated with the asset (e.g., whether the asset has more than 2 bedrooms), or user-asset attributes associated with both the user and the asset (e.g., whether the user has viewed this particular asset in the past 30 days). In certain implementations, the recommendation system 100 can programmatically select the set of user-asset attributes. For example, the classifier generator 130 or another component of the recommendation system 100 can determine strengths of correlation between each available user-asset attribute and the outcomes indicated in the training data 148 (e.g., whether a bid was submitted by the user). The classifier generator 130 can then select the user-asset attributes having the highest correlation as the set of user-asset attributes.

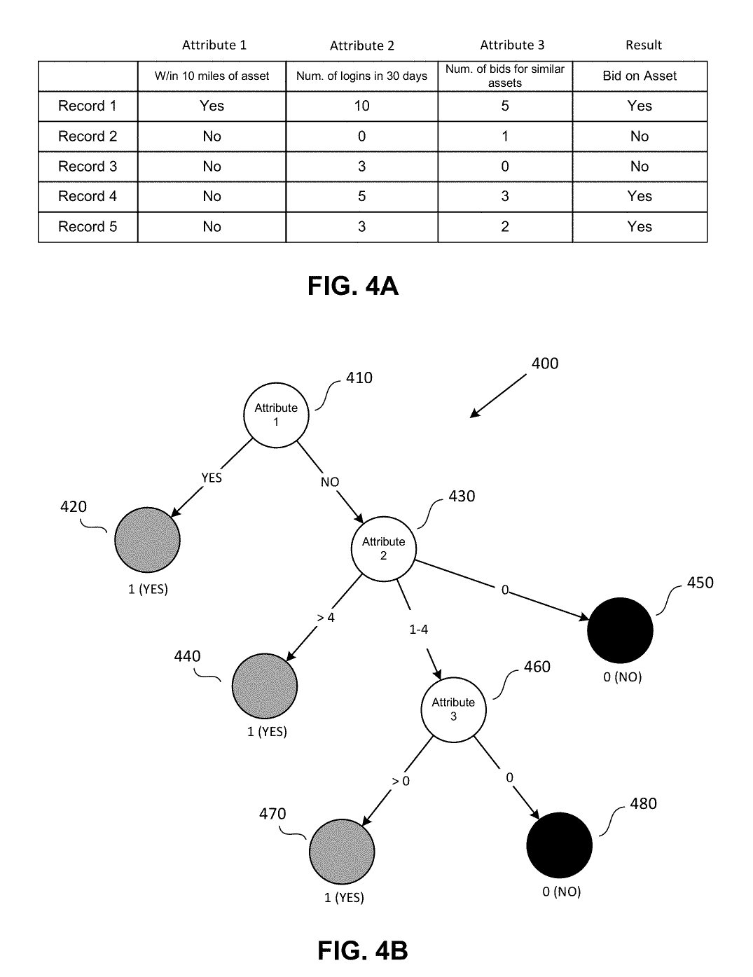

In various aspects, the model 131 can comprise a plurality of classifiers 132. Each classifier 132 can be associated with a subset of the set of user-asset attributes. Each classifier 132 can generate a classifier output. In some examples, the classifiers 132 are decision tree classifiers, such as the exemplary classifier illustrated in FIG. 4B, that can generate binary outputs (e.g., 1 or 0). In other examples, the classifiers 131 can be artificial neurons, perceptrons, quadratic classifiers, etc.

In one example, the model 131 is a Random Forest model comprising a plurality of classifiers 132, each being associated with a randomly selected subset of user-asset attributes. The model 131 can include a large number of such classifiers 132 (e.g., 500) and each classifier output can be equally weighted to compute the user-asset propensity score. The large number of classifiers and the random selection of user-asset attributes for each of the classifiers ensures that the model 131 is accurate even when some of the individual classifiers may have skewed or inaccurate outputs. The classifiers 132 can be structured and prioritized to minimize the deviance of classifier outcomes. The applied deviance function can be −2(n₁×log(p₁)+n₂×log(p₂)). Other optimizations for the classifiers can include applying the Residual Sum of Squares (RSS), or R², technique.

According to some examples, the recommendation system 100 can include propensity score engine 125 to compute user-asset propensity score 126 using the model 131 generated by modeling 130. The propensity score engine 125 receives asset data 146 and user data 147 that include information regarding a user-asset pair. In particular, the asset data 146 and user data 147 include values for the user-asset pair associated with the set of user-asset attributes used to generate model 131. The user-asset propensity score can be generated based on the classifier outputs. For instance, the propensity score engine 125 can determine an output for each of the classifiers 132 and average the classifier outputs to generate the user-asset propensity score. For instance, for a user-asset pair, outputs of 250 classifiers can be 1 and outputs of 250 classifiers can be 0. The resulting user-asset propensity score can be calculated as 0.5.

In various aspects, the computed user-asset propensity scores 126 can be stored in a database 140. The database 140 can store computed user-asset propensity scores for each unique user-asset combination. In some instances, the computation of user-asset propensity scores can be limited based on, for example, geography. For instance, only users and assets within a geographic region will be evaluated by the recommendation system 100. In this manner, unnecessary computations and processing can be avoided for users located far away from assets.

In the examples described herein, the recommendation system 100 can include a recommendation engine 135 to generate a recommendation based on the determined user-asset propensity scores. The recommendation engine 135 can receive a recommendation input 192 from the administrator 190 specifying parameters of the recommendation to be generated. For instance, the administrator 190 can specify an asset or user relevant to the recommendation, a type of recommendation, a number of assets or users to include in the recommendation, etc. In response, the recommendation engine 135 can query the database 140 to receive relevant user-asset propensity scores 141 and generate the requested recommendation 136. The generated recommendation 136 can be transmitted to the administrator.

As an example, the administrator 190 can request a recommendation regarding a particular asset. The administrator 190 can specify the type of the recommendation as a list of top ten users determined by the recommendation system 100 to be the most interested (e.g., most likely to submit a bid) on the particular asset. In response, the recommendation engine 135 can query the database 140 for all user-asset propensity scores 141 involving the particular asset. The recommendation engine 135 can determine, based on the user-asset propensity scores 141, the top ten users most likely to submit a bid on the particular asset. The recommendation engine 135 can generate recommendation 136 and transmit the recommendation 136 to the administrator 190.

Methodology

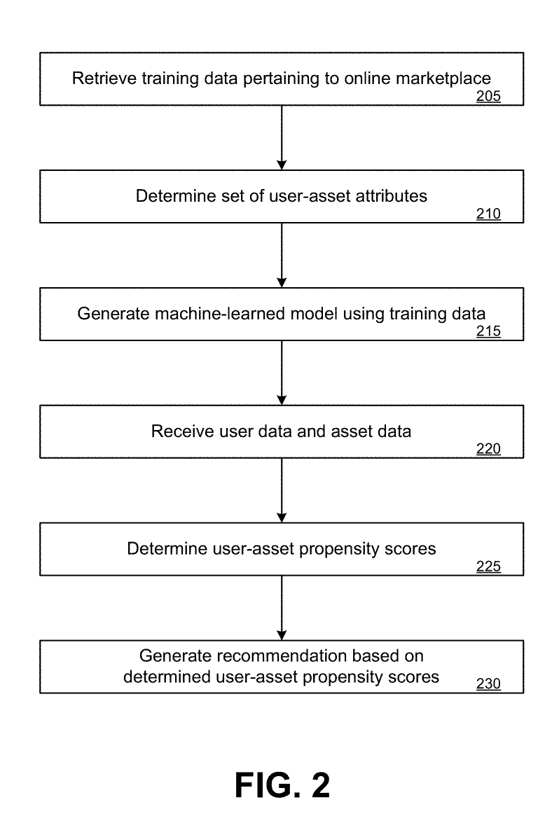

FIG. 2 is a flowchart diagram describing an example method of generating a recommendation based on user-asset propensity scores, in accordance with examples described herein. In the below discussion of FIG. 2, reference may be made to features and examples shown and described with respect to FIG. 1. For instance, the process illustrated by FIG. 2 can be performed by the exemplary recommendation system 100 described in FIG.

Referring to FIG. 2, the recommendation system 100 can retrieve training data pertaining to the online marketplace (205). The historical data can be received by the recommendation system 100 from a network system that implements the online marketplace. The training data can correspond to information regarding past bidding transactions (e.g., past bids, past transactions, past purchases, etc.) or to information regarding past non-bidding activities (e.g., a user's search of assets, a users' saving of an asset, etc.). Each training data record can be associated with a user and an asset. For instance, a record relating to a past bid is associated with the bidding user and the asset on which the bidding user placed the bid.

In some examples, the recommendation system 100 can determine a set of user-asset attributes (210). In other examples, the set of user-attributes can be determined by an administrator or an operator of the recommendation system 100 or of the online marketplace. User-asset attributes can be characteristics associated with users, assets, or user-asset combinations (e.g., “Whether a particular user has saved the particular asset as a favorite in the user's profile?”). In particular, some or all of the records in the training data have values associated with the set of user-asset attributes. For instance, a historical record corresponding to a past bid by a particular user on a particular asset can have a value of 0 (e.g., “No”) or 1 (e.g., “Yes”) associated with the user-asset attribute of “Whether a particular user has saved the particular asset as a favorite in the user's profile?” In various aspects, the recommendation system 100 (or the administrator or operator) can select user-asset attributes having the strongest correlation (e.g., either strong positive correlation or strong negative correlation) with the outcome indicated in the historical record (e.g., whether the user bid on the asset). For instance, user-asset attributes such as “Whether the user resides within a 10 mile radius of the asset location?” may be particularly strongly correlated with whether the user bids on the asset.

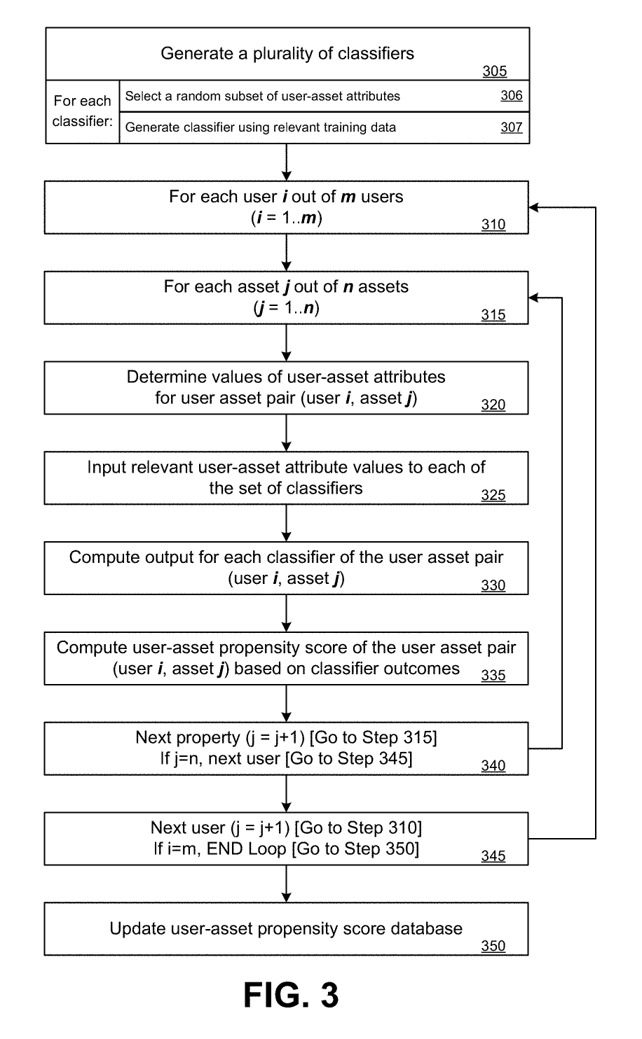

At step 215, the recommendation system 100 generates a machine-learned model using the training data. In particular, the recommendation system 100 can parse the training data to identify portions of the training data that are relevant to the determined set of user-asset attributes to generate the machine-learned model. The machine-learned model, generated using training data associated with the online marketplace, can be used to make predictions regarding user-asset combinations (e.g., by generating user-asset propensity scores). Such predictions can indicate, for example, a likelihood a particular user is to submit a bid on a particular asset. In some examples, the machine-learned model is a random forest model comprising a plurality of decision tree classifiers. Details regarding the generation of the plurality of decision tree classifiers are discussed, for example, with respect to FIG. 3 below. Other machine-learned models, such as neural networks, can also be generated by the recommendation system 100.

In certain implementations, machine-learned models can be geographically-specific. For instance, one model can be generated for the San Francisco Bay Area and another model can be generated for New York City. This can be achieved by segregating or filtering the training data by the geographic region associated with each historical record (e.g., location of the asset viewed, location of the asset bid on, location of the user, etc.). In this manner, only training data relevant to a particular geographic region can be used to generate the machine-learned model corresponding to that particular geographic region. In many instances, correlations between user-asset attributes and bidding activity can be different from one geographic region to the next. For example, in New York City, there may be a strong correlation between properties' proximity to mass transit hubs (e.g., subway stations) and bidding activity. In contrast, in Los Angeles, such a correlation may not exist. Thus, by separately creating separate machine-learned models for each geographical region, the recommendation system 100 can generate machine-learned models that are better tailored to each particular geographical region.

In the examples described herein, the recommendation system 100 receives user data and asset data (220). The user data can correspond to data regarding current users of the online marketplace. The user data can correspond to a subset of users of the online marketplace for which user-asset propensity scores are to be computed. Similarly, the asset data can correspond to a subset of available assets (e.g., currently available, soon-to-be-available, etc.) for sale on the online marketplace. In one example, the subsets of user data and asset data are geographically-specific. For instance, the user data can correspond to all active users of the online marketplace who are interested in assets located in the Greater Los Angeles Area and the asset data can correspond to all available assets of the online marketplace located in the Greater Los Angeles Area. In this manner, the recommendation system 100 can avoid determining user-asset propensity scores for needless combinations of users and assets (e.g., a user interested in the Greater Los Angeles Area and an asset in New York City). In addition, as described above, the machine-learned models can be geographically-specific as well.

According to embodiments, the recommendation system 100 can determine user-asset propensity scores (225) by applying the received user data and asset data as inputs to the machine-learned models generated at step 215. In certain examples in which the generated machine-learned model comprise decision tree classifiers, the recommendation system 100 can, for each user-asset combination, set values of the set of user-asset attributes as inputs to the decision tree classifiers to generate classifier outputs. Each classifier output can be a binary value (e.g., 0 or 1). The recommendation system 100 can average the classifier outputs to obtain the user-asset propensity score for the particular user-asset combination. This series of operations can be performed for each user-asset combination, using the associated user and asset data for the particular user and asset. In this manner, a respective user-asset propensity score can be computed for each unique user-asset combination.

In various aspects, the recommendation system 100 can generate recommendations based on the determined user-asset propensity scores (230). The recommendation system 100 can store the computed user-asset propensity scores in a database (e.g., database 140 of FIG. 1) and can query the database for user-asset propensity scores based on administrator input to generate a recommendation. For example, the administrator may input an asset ID identifying a particular asset for sale on the online marketplace. In response, the recommendation system 100 can query the database to obtain all user-asset propensity scores relevant to the particular asset. The recommendation system 100 can then generate a recommendation based on the relevant user-asset propensity scores obtained in response to the query. As an example, the administrator can receive, in response to the input of the asset ID identifying the particular asset, a recommendation comprising a list of users who are determined by the recommendation system 100 to be most likely interested in the particular asset. The list of users can be ranked based on their respective user-asset propensity scores. Furthermore, the list of users can be filtered (e.g., based on certain user-asset attributes). Similarly, the administrator can input a user ID identifying a particular user to obtain a recommendation comprising a list of assets the particular user is most likely interested in, as determined by the respective user-asset propensity scores. Examples provide that the recommendation system 100 can further generate reports based on user-asset propensity scores.

FIG. 3 is a flowchart diagram describing an example method of generating a user-asset propensity score using classifiers, in accordance with examples described herein. In the below discussion of FIG. 3, reference may be made to features and examples shown and described with respect to FIGS. 1 and 2. For instance, the process illustrated by FIG. 3 can be performed by the exemplary recommendation system 100 described in FIG. 1. Furthermore, the process of generating a user-asset propensity score can be a portion of the process illustrated in FIG. 2 (e.g., steps 215 and 225).

Referring to FIG. 3, the recommendation system 100 can be configured to generate a plurality of classifiers (305). This step can be a part of the machine-learning modeling performed by the recommendation system 100 (e.g., at step 215 of FIG. 2) using training data associated with the online marketplace. For instance, the machine-learned model can comprise the plurality of classifiers. In some examples, the machine-learned model is a random forest model that comprises a plurality of decision tree classifiers, each being generated based on a randomly selected subset of the set of user-asset attributes. The outputs of each of the classifiers in the random forest model can be equally weighted. In these examples, a random subset of user-asset attributes is selected for each classifier (306) from a set of user-asset attributes used to generate the machine-learned model (e.g., determined at step 210 of FIG. 2). Based on the randomly selected subset of user-asset attributes, each classifier can be generated using relevant portions of the training data (307). For instance, a classifier associated with a subset of user-asset attributes can be generated using portions of training data that are relevant to the subset of user-asset attributes.

At steps 310 and 315, the recommendation system 100 steps through each unique user-asset combination for which user-asset propensity scores are to be determined. Accordingly, the recommendation system 100 can perform steps 320 to 335 for each unique pairing of user and asset. As illustrated in FIG. 3, there may be m users and n assets. In one example, the m users can correspond to the number of active users of the online market place of a geographic region (e.g., users located in the geographic region, users interested in purchasing assets located in the geographic region, etc.). Similarly, the n assets can correspond to the number of available assets for sale on the online marketplace within the geographic region. In other examples, the administrator can select the m users and n assets from a database of users and assets. Still further, the m users can correspond to all active or all registered users of the online marketplace and the n assets can correspond to all assets available for sale on the online marketplace.

In certain implementations, the recommendation system 100 determines values of the set of user-asset attributes for each user-asset pair (e.g., user i and asset j) based on the user data and asset data (320).

The recommendation system 100 can input, to each of the plurality of classifiers, values of relevant user-asset attributes (325). Each of the classifiers can be associated with a subset of the set of user-asset attributes.

After inputting the relevant user-asset attribute values to each of the plurality of classifiers, the recommendation system 100 can compute the output for each classifier (330).

At step 335, the recommendation system 100 computes the user-asset propensity score for the user-asset pair (user i, asset j). In examples in which the machine-learned model of the recommendation system 100 comprises a plurality of decision tree classifiers, the recommendation system 100 can perform step 335 so by averaging the outputs of the classifiers.

At step 340, the recommendation system 100 proceeds to the next asset (asset j+1) of the n assets. If all user-asset propensity scores have been computed for the n assets with respect to user i, the recommendation system 100 can proceed to

Training Data and Classifier Examples

FIG. 4A is a diagram illustrating a representation of training data used to generate machine learning models for generating user-asset propensity scores, in accordance with examples described herein. In the below discussion of FIGS. 4A and 4B, references may be made to FIGS. 1-3. In particular, the training data represented by FIG. 4A can be received by recommendation system 100 of FIG. 1 to generate a machine-learned model that, in certain embodiments, can include decision tree classifiers such as the one illustrated in FIG. 4B.

Training data can include a number of records. Each of the records can be associated with a user and an asset. A record can include the user's transaction activity with respect to the asset. For instance, the record can include information regarding whether the user placed a bid on the property. The record can also include user-asset attribute values for the user and the asset. Training data records can be collected and maintained by one or more network systems associated with the online marketplace.

Referring to FIG. 4A, the training data is represented in a tabular format in which each training data record is shown in a different row. For simplicity and purposes of illustration, training data represented in FIG. 4 includes five records each with values corresponding to three user-asset attributes. The three user-asset attributes include whether the user lives within ten miles of the asset (Attribute 1), the number of times the user logged in to the online marketplace within the thirty days prior to the record being created (Attribute 2), and the number of bids the user had previously submitted for assets that are comparable (Attribute 3). The values corresponding to each of the user-asset attributes are represented in a different column in FIG. 4A. In addition, each training data record includes information regarding a result. In this instance, the result corresponds to whether the user had submitted a bid on the asset. In addition, a training data record can include information such as the user ID of the user associated with the record and the asset ID of the asset associated with the record.

As illustrated in FIG. 4A, Record 1, being associated with a first user and a first asset, indicates that: (i) the first user lives within ten miles of the first asset (Attribute 1), (ii) the first user had logged onto the online marketplace ten times within the thirty days of Record 1 being created (Attribute 2), (iii) the first user submitted, on the online marketplace, five bids on assets determined to be similar to the first asset (Attribute 3), and (iv) the first user submitted a bid on the first asset (Result). As another example, Record 2, being associated with a second user and a second asset, indicates that: (i) the second user does not live within ten miles of the second asset (Attribute 1), (ii) the second user had logged onto the online marketplace one time within the thirty days of Record 2 being created (Attribute 2), (iii) the second user submitted, on the online marketplace, one bid on assets determined to be similar to the second asset (Attribute 3), and (iv) the second user did not submit a bid on the second asset (Result).

The training data illustrated in FIG. 4A can indicate past user behavior on the online marketplace (e.g., submitting bids, favoriting assets, etc.). As such, the training data can be used to generate one or more machine-learned models with which predictions regarding future user behavior can be performed. In particular, a propensity score between a user and an asset can be determined based on training data regarding other users. The recommendation system 100 can parse and analyze the information represented in training data similar to the data illustrated in FIG. 4A to generate the machine-learned model used to compute user-asset propensity scores. In the example illustrated in FIG. 4A, for example, the training data can a portion of a much larger training data set. The data illustrated in FIG. 4A can be used to generate one decision tree classifier within the machine-learned model.

FIG. 4B is a diagram illustrating an example decision tree classifier generated by the example training data illustrated in FIG. 4A, in accordance with examples described herein. The machine-learning model generated by recommendation system 100 can comprise decision tree classifier 400 illustrated in FIG. 4B. In particular, the decision tree classifier 400 can be generated by the recommendation system 100 using the training data illustrated in FIG. 4A.

In an example, decision tree classifier 400 can comprise a plurality of nodes 410-480. Because the decision tree classifier 400 is generated by the recommendation system 100 based on the training data, the structure (e.g., the nodes and the branches) of the classifier 400 is based on the training data. In the example illustrated, nodes 410, 430, and 460 are internal nodes. The internal node 410 corresponds to Attribute 1 depicted in FIG. 4A. Similarly, the internal nodes 430 and 460 correspond to Attribute 2 and Attribute 3, respectively. Nodes 420, 440, 470, 470, and 480 are output nodes. Once traversal of the decision tree classifier 400 reaches an output node, the traversal is terminated and an output is generated for the user-asset pair.

As described above, the recommendation system 100 can generate the decision tree classifier 400 based on the training data records. Based on the five training data records depicted in FIG. 4A, the recommendation system 100 can generate the decision tree classifier 400 shown in FIG. 4B. For instance, information contained in Record 1 (e.g., corresponding user was located within ten miles of the corresponding asset and submitted a bid on the corresponding asset) is used to generate the decision tree branch leading to output node 420. Information contained in Record 4 (e.g., corresponding user logged onto the online marketplace five times in the thirty days prior to the record being created and submitted a bid on the corresponding property) is used to generate the decision tree branch leading to output node 440. Information contained in Record 2 (e.g., corresponding user did not log onto the online marketplace in the thirty days prior to the record being created and did not submit a bid on the corresponding property) is used to generate the decision tree branch leading to output node 450. Information contained in Record 5 (e.g., corresponding user placed two bids on assets deemed to be similar to the corresponding asset and submitted a bid on the corresponding asset) is used to generate decision tree branch leading to output node 470. Information contained in Record 3 (e.g., corresponding user did not submit bids on assets deemed to be similar to the corresponding asset and did not submit a bid on the corresponding asset) is used to generate decision tree branch leading to output node 480.

In various aspects, decision tree classifier 400 can classify a user-asset pair with an output of 1 (e.g., indicating that the corresponding user being determined as likely to submit a bid on the corresponding asset) or 0 (e.g., indicating that the corresponding user being determined as likely to submit a bid on the corresponding asset). Output to decision tree classifier 400 can be obtained by computationally traversing the decision tree classifier 400 (e.g., based on values of user-asset attributes) to arrive at a resulting output node. For instance, a first user-asset pair having a value of “Yes” corresponding to Attribute 1 can be computed to have an output of 1. As another example, a second user-asset pair having values of “No” (Attribute 1), 2 (Attribute 2), and 0 (Attribute 3) can be computed to have an output of 0.

Computer System

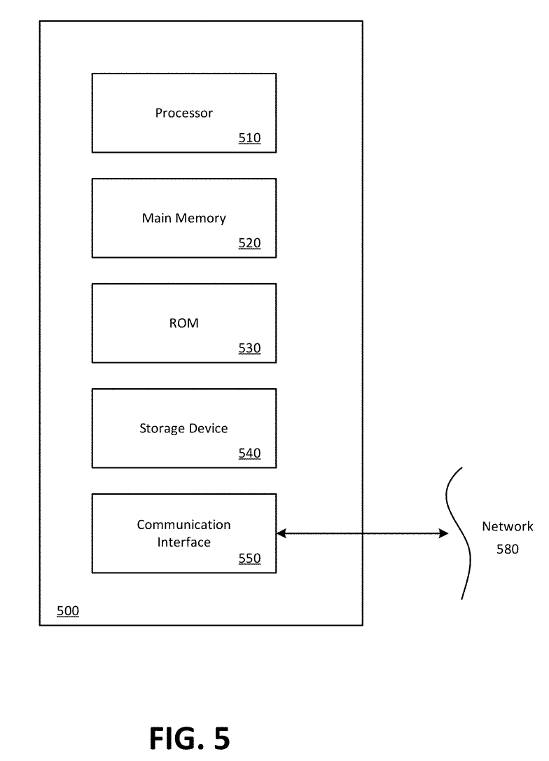

FIG. 5 is a block diagram that illustrates a computer system upon which embodiments described herein may be implemented. For example, in the context of FIG. 1, system 100 may be implemented using one or more servers such as described by FIG. 5. Likewise, a method such as described with FIG. 2 or FIG. 3 can be implemented using, for example, a computer system such as described with FIG. 5.

In an embodiment, computer system 500 includes processor 504, memory 506 (including non-transitory memory), storage device 510, and communication interface 518. Computer system 500 includes at least one processor 504 for processing information. Computer system 500 also includes the main memory 506, such as a random access memory (RAM) or other dynamic storage device, for storing information and instructions to be executed by processor 504. The memory 506 also may be used for storing temporary variables or other intermediate information during execution of instructions to be executed by processor 504. The memory 506 may also include a read only memory (ROM) or other static storage device for storing static information and instructions for processor 504. The storage device 510, such as a magnetic disk or optical disk, is provided for storing information and instructions. The communication interface 518 may enable the computer system 500 to communicate with one or more networks through use of the network link 520 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A method for generating recommendations related to an online marketplace, the method being implemented by one or more processors and comprising:
generating, based on training data associated with the online marketplace, a model comprising a plurality of classifiers;
for a user of the online marketplace and an asset for sale on the online marketplace:
computing outputs for the plurality of classifiers based on user data associated with the user and asset data associated with asset; and
computing a user-asset propensity score based on the plurality of classifier outputs.

2. The method of claim 1, further comprising generating a recommendation regarding predicted behavior of the user based on the user-asset propensity score.

3. The method of claim 2, wherein generating the recommendation comprises comparing the user-asset propensity score against a metric.

4. The method of claim 3, wherein the metric is a second user-asset propensity score.

5. The method of claim 1, wherein each of the plurality of classifiers is a decision tree.

6. The method of claim 1, wherein each of the plurality of classifiers is associated with a random subset of user-asset attributes.

7. The method of claim 1, wherein the model is a Random Forest Model.

8. The method of claim 1, wherein computing the user-asset propensity score comprises averaging the plurality of classifier outputs.

9. The method of claim 1, wherein the training data indicates historical user activity.

10. A recommendation system for an online marketplace comprising:
one or more processors; and
one or more memory resources storing instructions that, when executed by the one or more processors, cause the recommendation system to:
generate, based on training data associated with the online marketplace, a model comprising a plurality of classifiers;
for a user of the online marketplace and an asset for sale on the online marketplace:
compute outputs for the plurality of classifiers based on user data associated with the user and asset data associated with asset; and
compute a user-asset propensity score based on the plurality of classifier outputs.

11. The method of claim 10, wherein the executed instructions further cause the recommendation system to generate a recommendation regarding predicted behavior of the user based on the user-asset propensity score.

12. The method of claim 11, wherein generating the recommendation comprises comparing the user-asset propensity score against a metric.

13. The method of claim 12, wherein the metric is a second user-asset propensity score.

14. The method of claim 10, wherein each of the plurality of classifiers is a decision tree.

15. The method of claim 10, wherein each of the plurality of classifiers is associated with a random subset of user-asset attributes.

16. The method of claim 10, wherein the model is a Random Forest Model.

17. The method of claim 10, wherein computing the user-asset propensity score comprises averaging the plurality of classifier outputs.

18. The method of claim 10, wherein the training data indicates historical user activity.

19. A non-transitory computer-readable medium storing instructions that, when executed by one or more processors, cause the one or more processors to:
generate, based on training data associated with the online marketplace, a model comprising a plurality of classifiers;
for a user of the online marketplace and an asset for sale on the online marketplace:
compute outputs for the plurality of classifiers based on user data associated with the user and asset data associated with asset; and
compute a user-asset propensity score based on the plurality of classifier outputs.
